(19) United States
(12) Patent Application Publication
(10) Pub. No.: US 2026/0002992 A1
(43) Pub. Date: Jan. 1, 2026

(54) MEMORY DAMAGE DETECTION DURING INTEGRATED CIRCUIT DEVICE BOOT

(71) Applicant: ATI Technologies ULC, Markham (CA)

(72) Inventors: Hui Li, Markham (CA); Yifan He, Mississauga (CA); Xiong Yan, Markham (CA)

(73) Assignee: ATI Technologies ULC, Markham (CA)

(21) Appl. No.: 18/758,751

(22) Filed: Jun. 28, 2024

(51) Int. Cl. G01R 31/3187; G01R 31/28; G06F 21/57

(52) U.S. Cl. CPC G01R 31/3187; G01R 31/2853; G06F 21/575

(57) ABSTRACT

Detecting damage to a memory of an integrated circuit device includes initiating a boot process of the integrated circuit device. The boot process is implemented by a boot processor of the integrated circuit device. As part of the boot process, a die crack test of a memory device of the integrated circuit device is initiated. The memory device is coupled to the boot processor. The boot processor receives a result of the die crack test of the memory device during the boot process. The result of the die crack test is stored in a register of the integrated circuit device.

This disclosure relates to integrated circuit (IC) devices and, more particularly, to detecting damage to memory of an IC device during boot.

### BACKGROUND

A variety of modern integrated circuit (IC) devices are built using multiple chiplets, also referred to as dies, within a single package. As an example, an IC device may include one or more CPU chiplets, one or more GPU chiplets, and one or more memory chiplets coupled together within a single package. In many cases, memory is implemented within such devices as one or more High-Bandwidth Memory (HBM) stacks. An HBM stack is constructed of a plurality of stacked dies. Typically, an HBM stack includes a die configured to implement an interface and one or more memory dies stacked thereon. The interface die is also referred to as a “base” die and the memory dies are referred to as “core” dies.

Prior to an IC device being delivered to a customer or user, the IC device undergoes System Level Testing (SLT) to ensure that the IC device functions as expected. SLT is typically performed by IC manufacturers to simulate the operational environment belonging to the customer, also referred to as the customer telemetry, in which the IC device will be used.

### SUMMARY

In one or more embodiments, a method of operation for an integrated circuit device includes initiating a boot process of the integrated circuit device. The boot process is implemented by a boot processor of the integrated circuit device. The method includes, as part of the boot process, initiating die crack test of a memory device of the integrated circuit device. The memory device is coupled to the boot processor. The method includes receiving, by the boot processor, a result of the die crack test of the HBM stack during the boot process. The method includes storing the result of the die crack test in a register of the integrated circuit device.

In one or more embodiments, an integrated circuit device includes a boot processor capable of implementing a boot process by executing a bootloader. The integrated circuit device includes an HBM stack including a dedicated test port. The boot processor is coupled to the dedicated test port of the HBM stack. The boot processor, in response to executing one or more instructions of the bootloader, as part of the boot process, is capable of initiating a die crack test of the HBM stack.

In one or more embodiments, a computer program product includes one or more computer readable storage mediums having program instructions embodied therewith. The program instructions are executable by computer hardware, e.g., a hardware processor such as a boot processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an integrated circuit (IC) device in accordance with one or more embodiments of the disclosed technology.

FIG. 2 illustrates a cross-sectional side view of a portion of the IC device of FIG. 1 corresponding to cut-line 2-2.

FIG. 3 illustrates a cross-sectional side view of another example IC device in accordance with one or more embodiments of the disclosed technology.

FIG. 4 illustrates a boot processor coupled to an HBM stack in accordance with one or more embodiments of the disclosed technology.

FIG. 5 is an illustration of a die crack test that may be performed in a die of an HBM stack in accordance with one or more embodiments of the disclosed technology.

FIG. 6 is a flow chart illustrating a method of performing die crack testing during a boot process for an IC device in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuit (IC) devices and, more particularly, to detecting damage to memory of an IC device during boot. In accordance with the inventive arrangements described within this disclosure, an IC device having a plurality of subsystems is capable of implementing certain testing functions for memory of the IC device as part of a boot process.

In some cases, an IC device may suffer a subsystem failure. The failure may occur after the IC device has been provided to the customer and/or integrated into a customer computing environment, solution, or product. An example of a subsystem failure in an IC device is a memory of the IC device that fails. For purposes of illustration, an IC device may include one or more memory chiplets and/or one or more High-Bandwidth Memory (HBM) stacks that may experience a fault or damage of some type. An example of the sort of damage that may occur is die cracking.

In many cases, the only mechanism for diagnosing die crack or other damage in an HBM stack of an IC device is to initiate particular testing functions of the HBM stack. This testing is referred to as “die crack testing.” In some cases, the die crack testing is performed by test circuitry within the HBM stack that may be referred to as a Die Crack Monitor (DCM) circuit. In one or more embodiments, the DCM circuit implements testing that is capable of detecting whether the HBM stack is healthy along edge(s) of each die within the HBM stack. In conventional IC devices, this type of testing is invoked by way of a Joint Test Action Group (JTAG) port of the IC device.

In the usual case, accessing the JTAG port of an IC device requires that test personnel connect test equipment to the JTAG port by physically connecting a cable to the JTAG port of the IC device. For example, the JTAG port of the IC device is accessible via a physical port on the circuit board on which the IC device is disposed. This requires test personnel to have physical proximity and access to the IC device and/or circuit board.

Subsequent to system-level testing (SLT) performed by the IC device manufacturer or provider, and the IC device has been provided to a customer, physical access to the IC device is not always feasible. The IC device, for example, may be integrated into a customer computing solution and/or product and not be accessible for such testing. In the case of a data center computing environment, for example, the IC device may be disposed in a large rack of computing equipment. Further, the IC device may be one of many such IC devices housed in a plurality of racks. Test personnel are not always available or able to physically access the JTAG port of an IC device to gain access to the DCM circuit functionality necessary to diagnose the particular fault that may have occurred (e.g., detect a die crack condition in the HBM stack). Further, to access JTAG accessible functions, the IC device will have been booted in order to initiate the DCM circuit functionality.

In accordance with the inventive arrangements described within this disclosure, memory testing of an IC device is incorporated into a boot process of the IC device. With respect to memory devices such as memory chiplets and/or HBM stack(s) included in an IC device, each such structure may be tested for a fault condition and/or damage such as a die crack as part of the boot process of the IC device. As the IC device boots, for example, a DCM circuit, or other circuit and/or controller of a memory device providing similar and/or same functionality may be activated in each memory device of the IC device to detect damage such as die cracks of the memory device during boot of the IC device. In one or more embodiments, any die cracks of memory device(s) of the IC device may be detected during boot in real-time.

Boot level die crack testing provides several advantages over initiating die crack testing via JTAG. For example, die crack testing at boot time detects such conditions prior to any actual faults occurring during runtime of the IC device (e.g., after boot once the IC device is attempting to operate normally and/or execute applications). Otherwise, the IC device may complete the boot process such that executable program code such as user applications and/or data is loaded into the memory devices leading to data corruption and/or a potentially more serious fault at runtime. By performing die crack testing at boot time, the need for JTAG port access and/or direct physical access to the IC device by test personnel to initiate die crack testing is alleviated if not entirely eliminated.

By performing die crack testing at boot time and/or each time the IC device boots, the IC device may be flagged sooner rather than later so as to prevent the IC device from being delivered to a customer. Through integration into the boot process, die crack testing requires no special actions by users to initiate such testing. Further, implementing die crack testing at boot time can significantly reduce the amount of investigative work needed to pinpoint the type of fault and/or where the crack occurred. The inventive arrangements, being performed as part of a boot sequence, may be used and benefit both in-production SLT and in-customer platform telemetry.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

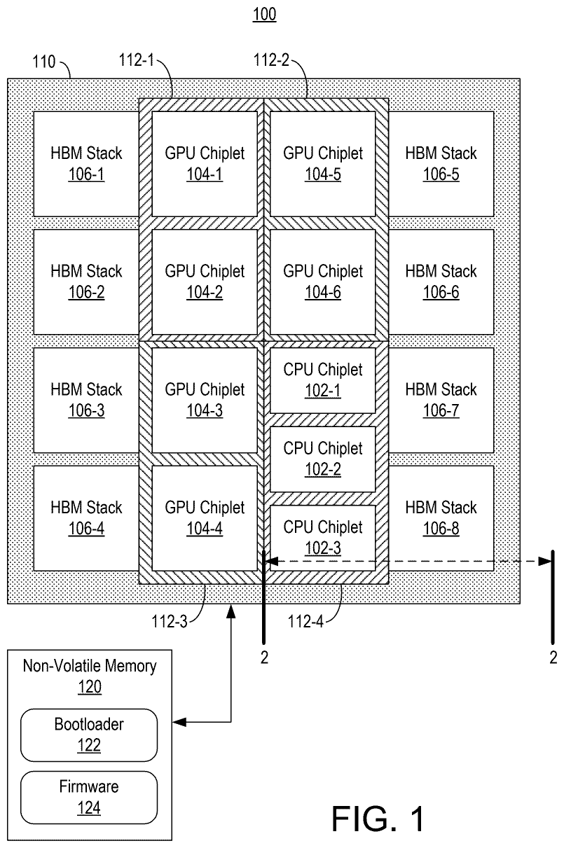

FIG. 1 illustrates an IC device 100 in accordance with one or more embodiments of the disclosed technology. In the example of FIG. 1, IC device 100 is implemented as a plurality of different subsystems. For purposes of illustration, the subsystems are embodied as chiplets (e.g., dies) and HBM stacks. In one or more embodiments, IC device 100 includes a combination of one or more Central Processing Unit (CPU) chiplets 102 (illustrated as CPU chiplets 102-1, 102-2, and 102-3), one or more Graphics Processing Unit (GPU) chiplets 104 (illustrated as GPU chiplets 104-1, 104-2, 104-3, 104-4, 104-5, and 104-6), and one or more memory devices. Each CPU chiplet 102 and GPU chiplet 104 may be an example of one or more hardware processors.

Within this disclosure, the term “memory device” refers to a volatile memory such as a Random Access Memory (RAM). A memory device may be implemented as a chiplet and/or an HBM stack. An example of a memory device implemented as a chiplet includes a RAM die such as Double Data Rate, Synchronous Dynamic Random Access Memory (DDR). In the example of FIG. 1, the memory devices are implemented as HBM stacks 106 (illustrated as HBM stacks 106-1, 106-2, 106-3, 106-4, 106-5, 106-6, 106-7, and 106-8).

For purposes of illustration and not limitation, each CPU chiplet 102 may be implemented as any of a variety of processor types. For example, CPU chiplets 102 may be implemented using a complex instruction set computer architecture (CISC), a reduced instruction set computer architecture (RISC), a vector processing architecture, or other known architectures. Example CPU chiplets include, but are not limited to, those having an x86 type of architecture (IA-32, IA-64, etc.), Power Architecture, ARM processors, and the like. Each CPU chiplet 102 may include one or more inter-connected cores. Each GPU chiplet 104 may be implemented as an accelerator. In one example implementation, each GPU chiplet 104 may be implemented as an accelerator complex die (XCD). Each GPU chiplet 104 may include a plurality of inter-connected compute units (e.g., circuits).

In one or more embodiments, each HBM stack 106 may be implemented in accordance with any of the existing HBM standards (e.g., version 1, 2, and/or 3) or in accordance with an HBM standard yet to be developed. Each HBM stack 106 may be implemented as a stack of synchronous dynamic random-access memory dies connected by way of through-silicon vias.

In the example of FIG. 1, HBM stacks 106 are disposed on an interposer 110. CPU chiplets 102 and GPU chiplets 104 are disposed on input/output (I/O) chiplets 112-1, 112-2, 112-3, and 112-4, which are in turn disposed on interposer 110. In the example, interconnect circuitry may be implemented in I/O chiplets 112 and within interposer 110.

In one or more embodiments, IC device 100 may be viewed as a self-contained computer system or server. For example, IC device 100, being a self-contained computer system or server, may be embodied as a single package that may be inserted or coupled to a socket on a circuit board. CPU chiplets 102 of IC device 100 may boot and execute an operating system. As such, certain components such as Dual In-Line Memory Modules (DIMMs) are eliminated. Other connections typically implemented off-chip such as CPU-to-GPU communication links are implemented within IC device 100. In an illustrative and non-limiting example, IC device 100 may be implemented as a MI300A APU available from Advanced Micro Devices, Inc. of Santa Clara, California.

IC device 100 may be coupled to a non-volatile memory 120. Non-volatile memory 120 may be implemented as a Read-Only Memory (e.g., an erasable programmable read-only memory or EPROM, electrically erasable programmable read-only memory (EEPROM)) or Flash memory. In the example, non-volatile memory 120 is capable of storing a bootloader 122 and/or firmware 124. Bootloader 122 may be implemented as a universal bootloader. Firmware 124 may include operational software such as one or more operating systems and/or user application program code that may be loaded into IC device 100 by bootloader 122 for execution. Both bootloader 122 and firmware 124 are examples of program code or computer-readable program instructions.

In one or more embodiments, IC device 100, as part of a boot process implemented by execution of bootloader 122, is capable of initiating one or more test functions of the various chiplets 102, 104, and/or HBM stacks 106 of IC device 100. For purposes of illustration, in the example of FIG. 1, a boot processor of IC device 100 is tasked with performing the operations (e.g., boot operations) of the boot process. For purposes of discussion the boot processor may be CPU chiplet 102-1 (or a particular core or hardware processor within CPU chiplet 102-1) that executes bootloader 122 from non-volatile memory 120. As part of that process, the boot processor is capable of initiating various tests within memory devices such as HBM stack(s) 106. Further, the boot processor may initiate various tests within other chiplets such as GPU chiplets 104 and/or CPU chiplets 102. In other embodiments, IC device 100 may include a separate and dedicated boot processor (not shown).

Within this disclosure, the term “core,” in reference to a CPU chiplet and/or a GPU chiplet refers to a processing circuit having an instruction execution capability and is to be differentiated from the term “core die” which refers to a particular type of die in an HBM stack.

FIG. 1 is provided for purposes of illustration and not limitation. FIG. 1 is not intended to suggest a particular type of packaging used for IC device 100 or the particular types of memory devices, chiplets, and/or subsystems included in IC device 100. One or more of the chiplets and/or HBM stacks may be implemented in a stacked die configuration with one or more dies and/or stacks of dies being disposed on an interposer or implemented using other available packaging technologies.

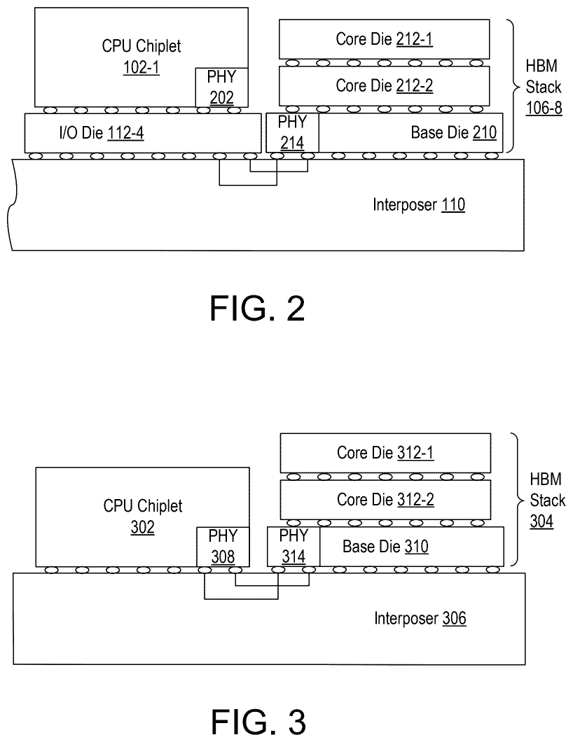

FIG. 2 illustrates a cross-sectional side view of a portion of IC device 100 of FIG. 1 corresponding to cut-line 2-2. FIG. 2 illustrates connectivity between CPU chiplet 102-1, e.g., the boot processor in this example, and HBM stack 106-8. It should be appreciated that the boot processor may be coupled to each HBM stack in the manner illustrated in FIG. 2. In the example, CPU chiplet 102-1 communicates with HBM stack 106-8 via a PHY 202 disposed therein. PHY 202 is coupled to I/O chiplet 112-4. I/O chiplet 112-4 is coupled to HBM stack 106-8 via wires implemented in interposer 110. As illustrated, HBM stack 106-8 is formed of a plurality of dies including a base die 210 and one or more core dies 212 (e.g., illustrated as core dies 212-1 and 212-2). Base die 210 may include a PHY 214. PHY 214 couples to I/O die 112-4 via the wires implemented in interposer 110.

A PHY is an electronic circuit implementation of the physical layer of the Open Systems Interconnection (OSI) model. The PHY may be implemented as a circuit block within a chiplet as illustrated in the examples provided within this disclosure. In other embodiments, a PHY may be implemented as a standalone chiplet that is part of a multi-chiplet device. For purposes of illustration and not limitation, in some embodiments, a PHY may include a Physical Medium Dependent (PMD) circuit, the PMD circuit having a receiver and a transmitter, a Physical Medium Attachment (PMA) circuit coupled to the PMD circuit, and one or more Physical Coding Sublayer (PCS) circuits coupled to the PMA circuit, wherein each PCS circuit is configured to implement a communication protocol.

In the example, PHY 214 may implement a plurality of different interfaces. In one or more embodiments, PHY 214 implements an I/O interface used for reading data from and/or writing data to base die(s) 212 during runtime operation (e.g., reading data from and writing data to a memory device such as HBM stack 106-8). PHY 214 may also implement one or more other interfaces such as a test interface that is reserved or dedicated for performing and/or initiating test functions. For example, PHY 214 may implement a dedicated test interface or port through which other entities such as the boot processor may initiate certain built-in self-test functions.

In the example of FIG. 2, the boot processor (e.g., CPU chiplet 102-1, a core of CPU chiplet 102-1, or a separate processor) is capable of initiating one or more built-in self-test functions of HBM stack 106-8 (and/or each other HBM stack 106 of IC device 100). More particularly, the boot processor is capable of communicating with each HBM stack 106 via a dedicated test port of each respective HBM stack 106 during boot (e.g., during a boot process) to initiate the built-in self-test function(s) in each HBM stack 106.

FIG. 3 illustrates a cross-sectional side view of another example IC device that includes a CPU chiplet 302 and an HBM stack 304 each disposed on an interposer 306. As shown, CPU chiplet 302 includes a PHY 308 that couples to a PHY 314 within a base die 310 of HBM stack 304. CPU chiplet 302 and HBM stack 304 communicate via PHYs 308 and 314 through interposer 306. HBM stack 304 further includes core dies 312-1 and 312-2 stacked atop of base die 310. The example of FIG. 3 is a simplified example of an IC device that includes a plurality of different subsystems implemented as one or more chiplets coupled to one or more HBM stacks. Like the example of FIG. 2, a boot processor, e.g., CPU chiplet 302, a core of CPU chiplet 302, or a separate processor, is capable of communicating with HBM stack 304 during boot (e.g., a boot process) to initiate one or more built-in self-test functions of HBM stack 304.

The example IC devices described herein are illustrated as being implemented using 2.5D packaging technology in which chiplets and/or HBM stacks are disposed on an interposer and/or other dies atop an interposer. Each HBM stack itself may be implemented using 3D packaging technology as a plurality of stacked dies. It should be appreciated that the particular IC devices illustrated within this disclosure are provided for purposes of illustration and not limitation. The inventive arrangements may be implemented for any of a variety of different types of IC devices implemented using any of a variety of packaging technologies that incorporate one or more memory devices such as HBM stacks, memory chiplets, or a combination thereof in communication with, e.g., coupled to, one or more compute enabled chiplets. In this regard, though HBM stacks are used to illustrate various aspects of the inventive arrangements, the embodiments described within this disclosure may be used for IC devices that also incorporate memory chiplets that support die crack testing. That is, die crack testing may be initiated as part of a boot process within an IC device for memory devices such as memory chiplets.

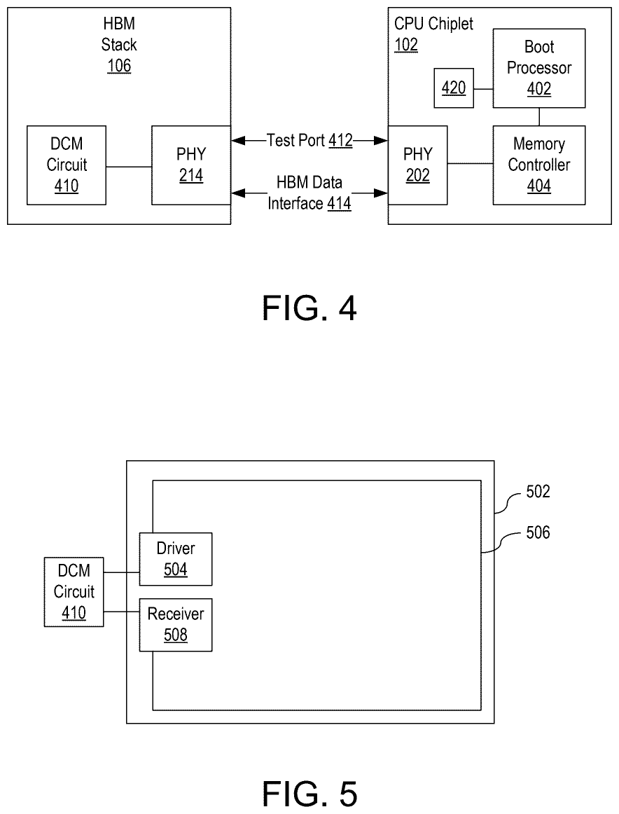

FIG. 4 illustrates an example of a boot processor 402 in communication with a memory device such as an HBM stack 106. In the example, boot processor 402 may correspond to CPU chiplet 102-1, a core disposed therein, or a dedicated boot processor. In another example, boot processor 402 may correspond to CPU chiplet 302, a core disposed therein, or a separate boot processor, with HBM stack 106 corresponding to HBM stack 304.

As illustrated, HBM stack 106 includes PHY 214. PHY 214 is coupled to DCM circuit 410. Further, boot processor 402 is coupled to PHY 202 by way of a memory controller 404. In the example, boot processor 402 may instruct memory controller 404 to initiate reads and/or writes of HBM stack 106 by way of HBM data interface 414 during runtime, e.g., normal, operation. As pictured, another separate and independent interface illustrated as test port 412 is provided. In the example, memory controller 404 may communicate with HBM stack 106 over test port 412 to initiate certain testing functions. Memory controller 404 may initiate the testing functions of HBM stack 106 under control, or responsive to commands from, boot processor 402.

For example, boot processor 402 is capable of submitting commands to memory controller 404. Memory controller 404, in response to the commands from boot processor 402, may submit commands to HBM stack 106 over test port 412 as part of the boot process of IC device 100. The commands from memory controller 404 sent over test port 412 may be directed to DCM circuit 410. In one or more embodiments, test port 412 is reserved, or dedicated, for initiating particular test modes and/or tests (e.g., built-in self-tests) of HBM stack 106. That is, such built-in self-tests of HBM stack 106 may only be initiated via test port 412. In some cases, test port 412 may be accessed via JTAG (not shown). As discussed, however, JTAG access requires physical access and a physical connection to IC device 100. Unlike JTAG, boot processor 402 may be configured, and/or programmed, to access test port 412 through execution of suitable program code as described herein in greater detail below.

In one or more embodiments, test port 412 may be implemented as an IEEE 1500 Port, which is a communication port that is compatible with the IEEE Standard 1500. The IEEE Standard 1500 is described, at least in part, as “a standard design-for-testability method for integrated circuits (ICs) containing embedded nonmergeable cores. This method is independent of the underlying functionality of the IC or its individual embedded cores. The method supports the necessary requirements for the test of such ICs, while allowing for ease of interoperability of cores that might have originated from different sources.”

In one or more embodiments, one of the tests that may be initiated and performed through test port 412 is a die crack test. A die crack test may be performed for memory devices. A die crack test is a test performed by a die (e.g., a memory chiplet) and/or a die stack (e.g., an HBM stack) that indicates whether a die or one or more die(s) of the memory device has sustained physical damage. The physical damage may arise from any of a variety of different causes. Example causes may include, but are not limited to, faulty manufacturing, faulty processes for mounting and/or including of the die or dies with one or more other dies (e.g., chiplets) and/or interposers in a packaged IC device (e.g., faulty packaging), and/or faulty handling of the IC device once manufactured and/or provided to an end user or customer. Physical damage may be induced, for example, as a consequence of physical forces and/or stresses placed on the die and/or dies.

In one or more embodiments, DCM circuit 410 is capable of initiating a die crack test, periodic die crack tests and/or testing, and/or continuous die crack tests and/or testing. In the example, DCM circuit 410 may be accessed, e.g., provided with instructions, by way of memory controller 404 over test port 412. Further, results obtained from any die crack test and/or testing performed by DCM circuit 410 may be output via test port 412 to memory controller 404 and/or boot processor 402. In one or more embodiments, DCM circuit 410 and PHY 214 may be disposed in a base die of HBM stack 106. The die crack testing may be performed for the base die and/or for each core die included in the die stack.

In the example, any results of die crack testing performed such as error code(s) may be received by boot processor 402 and stored in a register 420. In the example, register 420, e.g., a memory, is disposed within CPU chiplet 102. In other embodiments, register 420 may be disposed within boot processor 402. In still other embodiments, register 420 may be disposed external to CPU chiplet 102 and within the IC device. In one or more embodiments, register 420 is implemented as a volatile memory. In one or more other embodiments, register 420 is implemented as a non-volatile memory. In one or more embodiments, contents of register 420 may be reported to external systems or output from CPU chiplet 102 or the IC device via an output port. In one or more examples, register 420 may be an out bound register that may be read, monitored, and/or accessed by an external system (e.g., customer and/or user equipment). In one or more embodiments, register 420 may read, monitored, and/or accessed via an Out-of-Band (OOB) communication link to external equipment. The external equipment may be, for example, an administrative console or other system within a computing environment.

FIG. 5 is an example of a die crack test that may be performed in one or more or each die of a memory device. In the example of FIG. 5, a die 502 of a memory device such as an HBM stack is illustrated. Die 502 includes a driver 504 that is capable of sending a signal through conductor 506, e.g., a wire, to receiver 508. DCM circuit 410, in response to a request for die crack testing, is capable of causing driver 504 to output a signal on conductor 506 and causing read receiver 508 to detect whether the signal was received or detected. In the example, though illustrated as a single conductor, conductor 506 may be implemented as a plurality of conductors capable of conveying a plurality of parallel signals or bits. In that case, driver 504 may be capable of generating a signal on each of conductors 506 and receiver 508 may be capable of detecting or receiving the signal on each of conductors 506. Driver 504, for example, may be a multi-bit register to which data may be written. Receiver 508 is capable of receiving data via conductors 506 and store such data to be read by DCM circuit 410.

For purposes of illustration, a die crack test that indicates the detection of a die crack (e.g., physical damage of the die) will detect an open circuit on one or more of conductors 506. A closed loop or conductive path between driver 504 and receiver 508 on each conductor 506 indicates no die crack (e.g., no physical damage). In other examples, the value read from receiver 508 by DCM circuit 410 and returned to boot processor 402 will be a first value for a die crack test that was passed and a second, different value for a die crack test that was failed.

The example of FIG. 5 is provided for purposes of illustration and not limitation. In one or more other embodiments, different die crack tests may be performed and each such die crack test may differ from one memory device provider to another and/or from one memory device type to another. In one or more other examples, the die crack test may include or use (e.g., in lieu of the test illustrated in FIG. 5) a temperature test where one or more sensors are used to detect temperature at one or more locations throughout each die to detect damage (e.g., where abnormal temperature indicates a die crack). The inventive arrangements are not intended to be limited by the particular die crack testing performed.

In one or more embodiments, each die, whether a base die or a core die, of an HBM stack may include the circuitry illustrated in FIG. 5. For example, each base die and core die may include conductor 506 couple to DCM circuit 410 with DCM circuit 410 including the necessary drivers and receivers for each conductor 506 in each die. In another example, each die may include conductor 506, driver 504, and receiver 508 coupled to DCM circuit 410. In any case, die crack testing in each die may be initiated and/or controlled by DCM circuit 410.

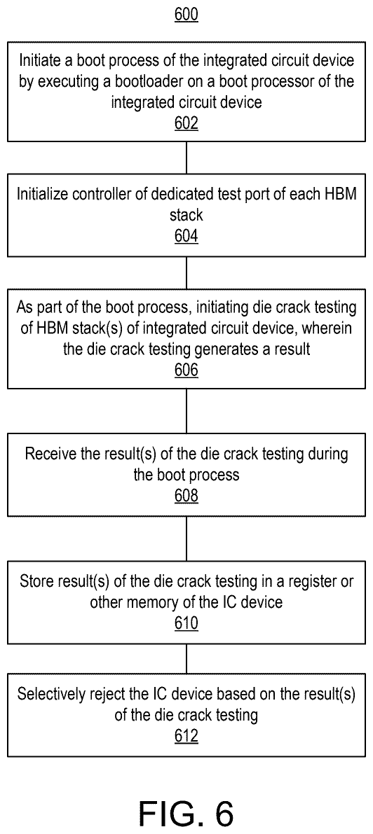

FIG. 6 is a method 600 of performing die crack testing during a boot process for an IC device in accordance with one or more embodiments of the disclosed technology. Method 600 may be performed by an IC device as described herein. For example, method 600 may be performed by an IC device as described with reference to FIG. 1 and/or FIG. 3. For purposes of illustration, method 600 is described with reference to IC device 100 of FIG. 1. As discussed, the inventive arrangements may be used to perform die crack testing during a boot process for any of a variety of IC devices that include one or more memory devices that include DCM circuit functionality (e.g., memory chiplets with DCM circuit functionality and/or HBM stacks with DCM circuit functionality).

In block 602, boot processor 402 (e.g., CPU chiplet 102-1) of IC device 100 is capable of initiating a boot process of the IC device. Boot processor 402 may initiate the boot process by executing bootloader 122. In one or more embodiments, the boot process is initiated in IC device 100 in response to a reset (e.g., a hard or soft power cycling) of IC device 100.

In block 604, as part of the boot process, the boot processor is capable of initializing memory controller 404. As noted, memory controller 404, once initialized, is capable of communicating with HBM stack 106 over test port 412. For example, the bootloader includes instructions that cause boot processor 402 to initialize memory controller 404 to establish communications with HBM stack 106 via test port 412. Memory controller 404 is initialized prior to initiating any communications with HBM stack 106 over test port 412. Further, memory controller 404 is initialized prior to being capable of performing any reads and/or writes over HBM data interface 414 during normal operation of the IC device subsequent to boot.

In block 606, as part of the boot process, boot processor 402 is capable of initiating a die crack test and/or testing of HBM stack 106. For example, the boot process is implemented by boot processor 402 executing bootloader 122 for IC device 100. Bootloader 122 includes instructions that, upon execution by boot processor 402, initiate the die crack testing within one or more or each HBM stack 106. By incorporating die crack testing in the bootloader, such testing may be performed at each boot up of IC device 100.

In one or more embodiments, boot processor 402, having initialized memory controller 404, sends commands to memory controller 404 to initiate die crack testing in each HBM stack 106. In response to the commands from boot processor 402, memory controller 404 initiates die crack testing in each HBM stack 106 via the respective test port 412 for each such HBM stack 106.

DCM circuit 410 receives instruction(s) to perform die crack testing from memory controller 404. In response to receiving the instruction(s), DCM circuit 410 initiates die crack testing for each die in HBM stack 106. In this manner, boot processor 402, through execution of bootloader 122, initiates die crack testing by invoking the DCM circuit 410 in each respective HBM stack 106. As noted, in some embodiments, test port 412, e.g., the dedicated test port, is implemented as an IEEE 1500 port. The die crack testing performed in the HBM stack generates a result. The result may indicate, on a per die basis, a pass or fail of each die of the HBM stack.

In one or more embodiments, boot processor 402 is capable of initiating the die crack testing in each HBM stack 106 of IC device 100 in parallel, e.g., simultaneously or in an overlapping manner. For example, boot processor 402 may cause memory controller 404 to broadcast instructions to initiate die crack testing to each HBM stack 106 of IC device 100. In one or more other embodiments, the boot processor may initiate the die crack testing of each HBM stack 106 serially such that memory controller 404 initiates serial testing of HBM stacks 106, e.g., one-by-one.

In one or more example implementations, the die crack testing illustrated in FIG. 5 may be performed for a particular die and/or may be performed for one or more or each metal layer of each die. For example, die crack testing performed for upper-metal layers of a die may be referred to as “upper-layer” or “high-level” die crack testing. Die crack testing for lower-metal layers of a die may be referred to as “lower-level” or “low-level” die crack testing. In this regard, the die crack testing illustrated in FIG. 5 may be performed for a given die and/or for one or more or each metal layer of a die and for each die of an HBM stack (e.g., for both the base dies and the core die).

In one or more embodiments, boot processor 402, via memory controller 404 and the processes described herein, is capable of sending commands to the base die and to the core die(s) of HBM stacks 106 separately. In one or more embodiments, boot processor 402 initiates and/or completes die crack testing in the base die of an HBM stack prior to initiating die crack testing in the core die(s). For purposes of illustration, boot processor 402 may first set the Wrapper Instruction Register (WIR) to instruct the HBM stack base die to begin testing. The WIR is loaded via a Wrapper Serial Port (WSP) with instructions that select the Wrapper Data Register (WDR). Next data is sent (e.g., 80 bits of data that may be over 3 WDR registers). The data may represent high-level and/or low-level data to be loaded into driver 504. Boot processor 402 monitors receiver 508. For purposes of illustration, successful low-level testing (e.g., no die crack detected) may return a 0 while successful high-level testing (e.g., no die crack detected) returns a 1. If a die crack is detected, the low-level testing and high-level testing will return different values.

Within each HBM stack, in response to a request for die crack testing as initiated by the boot processor, DCM circuit 410 may initiate a die crack test in the base die and also for each core die. DCM circuit 410, for example, may initiate such testing in serial or parallel on a per HBM stack basis and/or on a per die basis for each individual HBM stack.

In block 608, as part of the boot process, e.g., during the boot process, boot processor 402 is capable of receiving the result of the die crack test as performed by the HBM stack. Boot processor 402, for example, may receive a result of die crack test for each HBM stack of the IC device. The result for each HBM stack indicates whether a die crack has been detected in any of the dies therein. In one or more embodiments, the result may be specified on a per die basis for each HBM stack.

In block 610, boot processor 402 is capable of storing, or persisting, the result of the die crack testing in a register or other memory of IC device 100. The register or other memory may be one that may be read by an external system. For example, the register including the die crack test result may be read by the external system. In one or more other embodiments, the result(s) of the die crack testing may be output from a communication port of the IC device to another device coupled thereto. The communication port may be a JTAG port or another port that does not require physical proximity or cabling as is the case with a JTAG port. For example, the die crack test may be read by way of any of a variety of communication ports such as Universal Serial Bus (USB), Ethernet, Peripheral Component Interconnect Express (PCIe), or the like. The register in which the die crack testing results (e.g., error code(s)) are stored may be an OOB register that is accessible or readable by any of a variety of trusted systems and/or devices such as, for example, an administrative console.

In block 612, the IC device is selectively rejected based on the result(s) of the die crack testing. For example, in response to detecting that the result(s) indicate a failure of a die for the die crack testing, e.g., whether by reading the result(s) from the register or memory of the IC device or in response to receiving the result(s) from a communication port of the IC device, the IC device in which the failure is detected may be rejected or otherwise designated as faulty. A rejected IC device may be prevented from being delivered to a customer (e.g., discarded), taken offline, or otherwise disabled or removed from a computing system.

In cases where no die crack is detecting by the die crack testing performed, the IC device ma continue booting and begin normal operation. In that case, for example, memory controller 404 is capable of performing read and/or write operations to the memory devices using a runtime or standard data interface (e.g., HBM data interface 414 in the case of an HBM stack).

In one or more embodiments, boot processor 402, in executing the bootloader, may stop the boot process in response to detecting a die crack condition in a die, save the primary scene, and output a unique code. In outputting the unique code, determining the reason for the fault becomes straightforward allowing the faulty IC device to be rejected immediately. Were such testing as described herein not performed as part of booting the IC device, damage to a memory device may go unnoticed resulting in the damaged IC device being provided to a customer. Moreover, determining the cause of error in the IC device in such cases may require time-consuming and intensive debugging tests performed with physical access to a JTAG port.

In one or more embodiments, die crack testing may be initiated by boot processor 402 in one or more or all of the HBM stacks of the IC device so that such testing is performed in real-time during and/or throughout (e.g., continually throughout) the boot process.

In one or more embodiments, as certain HBM stacks provide one IEEE Standard 1500 port in which the standard specification is extended to replicate the Wrapper Serial Output (WSO) output for channel of the HBM stack individually, some commands provided to the HBM stack for die crack testing may be executed in the HBM stack in parallel, e.g., simultaneously, across a plurality of channels of the HBM stack. This eliminates the need for cross-channel arbitration for the WSO. As a result, complexity and potential bottlenecks are reduced or eliminated thereby enabling faster and more efficient memory operations and die crack testing of the HBM stack(s).

It should be appreciated that particular examples of die crack test(s) and/or testing, including particular values written and/or returned, as described within this disclosure are provided for purposes of illustration and not limitation. Different types of memory devices may implement die crack test(s) and/or testing differently in response to request for such testing from an external host, controller, or hardware processor. The inventive arrangements are not intended to be limited by the particular manner in which a memory device equipped with DCM circuitry and/or functionality implements die crack test(s) and/or testing and/or the particular messages and/or communication protocol(s) used to initiate the die crack test(s) and/or testing.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, neither a “computer-readable storage medium” nor “computer-readable storage mediums” is/are a transitory, propagating signal per se. The various forms of memory, as described herein, are examples of computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “hardware processor” means at least one hardware circuit. The hardware circuit is capable of carrying out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the term “program code” is used interchangeably with the term “program instructions” and/or “computer-readable program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of operation for an integrated circuit device, the method comprising:
initiating a boot process of the integrated circuit device, wherein the boot process is implemented by a boot processor of the integrated circuit device;
as part of the boot process, initiating a die crack test of a memory device of the integrated circuit device, wherein the memory device is coupled to the boot processor;
receiving, by the boot processor, a result of the die crack test of the memory device during the boot process; and
storing the result of the die crack test in a register of the integrated circuit device.

2. The method of claim 1, wherein the boot process is implemented by the boot processor executing a bootloader for the integrated circuit device, wherein the bootloader includes instructions that, upon execution, initiate the die crack test.

3. The method of claim 1, wherein the initiating the boot process is performed in response to a reset of the integrated circuit device.

4. The method of claim 1, wherein the die crack test is initiated by the boot processor invoking a die crack monitor (DCM) circuit of the memory device through a dedicated test port of the memory device.

5. The method of claim 4, further comprising:
prior to initiating the die crack test of the memory device, initializing, by the boot processor, a memory controller capable of communicating with the memory device over the dedicated test port.

6. The method of claim 4, wherein the dedicated test port is an IEEE 1500 port.

7. The method of claim 1, wherein the memory device is one of a plurality of memory devices of the integrated circuit device, and wherein the method comprises:
initiating the die crack test in each of the plurality of memory devices of the integrated circuit device.

8. The method of claim 7, wherein the die crack test of the plurality of memory devices is initiated in parallel.

9. The method of claim 1, further comprising:
rejecting the integrated circuit device in response to the result of the die crack test of the memory device indicating a die crack.

10. The method of claim 1, wherein the memory device is a memory chiplet.

11. The method of claim 1, wherein the memory device is a High-Bandwidth Memory stack.

12. An integrated circuit device, comprising:
a boot processor capable of implementing a boot process by executing a bootloader; and
a high-bandwidth memory (HBM) stack including a dedicated test port, wherein the boot processor is coupled to the dedicated test port of the HBM stack;
wherein the boot processor, in response to executing one or more instructions of the bootloader, as part of the boot process, is capable of initiating a die crack test of the HBM stack.

13. The integrated circuit device of claim 12, wherein the boot processor is capable of, in response to receiving a result of the die crack test, storing a result of the die crack test in a register.

14. The integrated circuit device of claim 12, wherein the boot processor is capable of initiating the boot process in response to a reset of the integrated circuit device.

15. The integrated circuit device of claim 12, wherein the boot processor, prior to initiating the die crack test of the HBM stack, initializes a memory controller capable of communicating with the HBM stack over the dedicated test port.

16. The integrated circuit device of claim 12, wherein the die crack test is initiated by the boot processor invoking a die crack monitor (DCM) circuit of the HBM stack through the dedicated test port.

17. The integrated circuit device of claim 12, wherein the dedicated test port is an IEEE 1500 port.

18. The integrated circuit device of claim 12, wherein the HBM stack is one of a plurality of HBM stacks, and wherein the boot processor initiates the die crack test in each HBM stack of the plurality of HBM stacks.

19. The integrated circuit device of claim 18, wherein the die crack test of the plurality of HBM stacks is initiated in parallel.

20. The integrated circuit device of claim 12, wherein the integrated circuit device is rejected in response to detecting a result of the die crack test of the HBM stack indicating a die crack.
